(19) United States
(12) Patent Application Publication
(10) Pub. No.: US 2024/0183280 A1
(43) Pub. Date: Jun. 6, 2024

(54) DRIVE UNIT

(71) Applicant: Barbara LEONE-MEIER, Fahrweid (CH)

(72) Inventor: Demetrio Leone, Fahrweid (CH)

(73) Assignee: Patric Leone, Zürich (CH)

(21) Appl. No.: 18/283,716

(22) PCT Filed: Mar. 30, 2022
(86) PCT No.: PCT/EP2022/058462

§ 371 Date: Sep. 22, 2023

(30) Foreign Application Priority Data
Mar. 30, 2021 (EP) 21166122.8

(51) Int. Cl. F01D 15/10; H02K 7/18

(52) U.S. Cl. CPC F01D 15/10; H02K 7/1823; F05D 2220/76

(57) ABSTRACT

A drive unit for a generator comprises a housing, a flow channel for a compressible medium, a drive impeller and a driven impeller. The flow channel is arranged in the housing, the flow channel extending from the drive impeller to the driven impeller. The drive impeller is rotatably mounted on a drive shaft and the driven impeller is rotatably mounted on an output shaft. At least one of the drive shafts or output shafts is rotatably mounted in the housing. The housing contains a flow body which is arranged between the drive impeller and the driven impeller.

The present invention relates to a drive unit for a generator, for example for operating a plant for generating electrical energy, which can comprise a plurality of drive units.

A transportable power plant module is known, for example, from RU2059779 C1. The power plant module is arranged in a transportable container and contains several cells for a control device, a gas turbine and a generator. RU2059779 C1 describes the mounting of the gas turbine on frictionless bearings, which allow vertical alignment of the gas turbine and generator and their coaxial alignment with each other. The gas turbine and the generator are connected by a horizontally arranged drive shaft. However, this patent specification does not refer to the power source used to operate the gas turbine.

U.S. Pat. No. 5,687,560 describes a power plant driven by a gas turbine which serves to drive a generator for the production of electrical energy. In such a power plant, air is compressed by means of a multi-stage compressor. The compressors are connected to one or more turbines via a common shaft. The air flowing through the compressors rises to temperatures of over 600 degrees Celsius. The heated air is used to preheat a fuel, for which purpose an air-fuel heat exchanger is arranged in the compressors' exhaust air stream. The fuel heated by the air-fuel heat exchanger is in turn used for a burner arranged between the compressors and the turbines on the common shaft. The burner is used to heat the air flowing through the turbines, which drives the turbines and, via the common shaft, the compressors. The hot exhaust air from the turbines can be fed into a regenerator, i.e., another heat exchanger, to preheat the compressed air flowing into the burner. Before the hot exhaust air from the turbines is fed into the recuperator, it can be passed through another turbine used to drive a generator.

Therefore, there is a need for a mobile power plant unit by means of which electricity can be generated without relying on an existing energy source. Such a mobile power plant unit should thus be able to be used for decentralized power generation. Such a power plant unit is designed to operate at temperatures of more than 1000 degrees Celsius and pressures of several MPa.

The applicant's EP19199459.9 therefore sought a solution for adapting this technology to the use of waste heat in order to generate decentralized electrical energy from compressible media occurring in production plants, for example exhaust air streams, which have temperatures of maximum 200 degrees Celsius and pressures in the range of 0.5 to 10 bar.

In tests with prototypes, the applicant has found that the arrangement of a power plant unit described in EP 19199459.9 with a drive shaft running in the horizontal direction is associated with disadvantages if the flow velocities are low for the temperature and pressure range mentioned.

It is thus the object of the invention to provide a drive unit for a generator by means of which the conversion of thermal energy of a compressible medium into electrical energy can take place with improved efficiency, in particular when the drive unit is operated at temperatures of maximum 200 degrees Celsius and pressures of 0.5 to 10 bar.

The problem of the invention is solved by a drive unit for a generator, which is configured for operation with a heated compressible medium.

When the term “for example” is used in the following description, this term refers to examples of embodiments and/or variants, which is not necessarily to be understood as a more preferred application of the teaching of the invention. Similarly, the terms “preferably”, “preferred” are to be understood as referring to an example from a set of embodiments and/or variants, which is not necessarily to be understood as a preferred application of the teaching of the invention. Accordingly, the terms “for example”, “preferably”, or “preferred” may refer to a plurality of embodiments and/or variants.

The following detailed description contains various examples of embodiments of the drive unit according to the invention. The description of a particular drive unit is to be regarded as exemplary only. In the description and claims, the terms “include”, “comprise”, “have” are interpreted as “include but are not limited to”.

A drive unit for a generator according to the present invention comprises a housing, a flow channel for a compressible medium, a drive impeller and a driven impeller. The flow channel is disposed in the housing. The flow channel extends from the drive impeller to the driven impeller. The drive impeller is rotatably mounted on an drive shaft, and the driven impeller is rotatably mounted on an output shaft. At least one of the drive shaft and the output shaft is rotatably supported in the housing. The housing contains a flow body, the flow body being disposed between the drive impeller and the driven impeller.

The flow body is arranged in particular inside the flow channel. The flow body can form the inner wall of the flow channel, at least in sections. The flow body shapes the flow cross-section of the flow channel in such a way that the flow velocity of the compressible medium in the flow channel increases or decreases when a compressible medium flows through the flow channel. According to an embodiment, the flow cross-section of the flow channel continuously decreases in the flow direction. According to an embodiment, the flow cross-section of the flow channel for the compressible medium increases continuously in the flow direction. In particular, the flow body is configured in such a way that the flow cross-section of the flow channel is continuously reduced by the flow body in the flow direction of the compressible medium. According to an embodiment, the flow body is configured in such a way that the flow cross-section of the flow channel continuously increases in the flow direction of the compressible medium. According to an embodiment, the flow cross-section, i.e., the cross-section through which fluid flows, of the flow channel continuously decreases downstream of the inlet in the flow direction of the compressible medium and then continuously increases.

According to an embodiment, the flow channel has a plurality of flow channel sections. In particular, the flow channel can be configured such that the flow velocity of the compressible medium in the flow channel increases in a first flow channel section and decreases in a second flow channel section. In particular, the flow body is configured in such a way that the flow cross-section of the first flow channel section is continuously reduced by the flow body in the flow direction of the compressible medium, so that the flow velocity of the compressible medium in the first flow channel section increases. According to an embodiment, the flow body is configured in such a way that the flow cross-section of the second flow channel section continuously expands in the flow direction of the compressible medium, so that the flow velocity of the compressible medium in the second flow channel section decreases.

According to an embodiment, at least one of the drive shaft and the output shaft is rotatably arranged in a recess of the flow body or extends through the flow body. The drive shaft and the output shaft may be integrally formed, i.e., formed by a single shaft. According to this embodiment, the recess is formed as a through hole. The through-hole runs coaxially to the longitudinal axis through the flow body. If it is expedient for assembly reasons, the drive shaft and the output shaft can also be coupled to each other. For example, the drive shaft and the output shaft can be connected to each other with a plug-in connection to prevent rotation.

According to an embodiment, the drive shaft and the output shaft are not coupled to each other. The drive shaft can, for example, be rotatably mounted in a bore in the flow body. The output shaft may be rotatably mounted in a bore in the flow body. Each of the bores may be arranged coaxially with respect to the longitudinal axis and, in particular, may extend in the direction of the longitudinal axis. Each of the bores is designed as a blind bore according to this embodiment. It is also possible to couple the drive shaft and the output shaft via a plug-in connection extending in a through bore in the housing, in particular in the flow body, in such a way that the drive shaft can be rotated relative to the output shaft.

In particular, the drive unit can be arranged in such a way that the inlet is located below the outlet. According to the embodiment, the compressible medium flows through the drive unit from bottom to top. In particular, the longitudinal axis can extend in a vertical direction. At least one of the drive shafts and output shafts can extend in vertical direction.

According to an embodiment, the flow channel divides downstream of the drive impeller into a first channel portion and a second channel portion. In particular, the mouth region can be located at a point on the flow channel that is between the inlet and the outlet. If the flow channel comprises a first flow channel section and a second flow channel section, the second channel portion can open into the first channel portion in particular in the region in which the transition from the first flow channel section to the second flow channel section is located.

According to an embodiment, a heating element is arranged between the first and the second channel. The heating element is configured in particular for heating the compressible medium flowing in the second partial channel.

In particular, the second partial channel can open into the first partial channel, with the second partial channel in particular opening into the first partial channel in a mouth region at which the flow channel has the smallest flow cross section. An advantage of this arrangement is that the flow velocity in the first partial channel is at a maximum in the mouth region. The compressible medium flowing in the second partial channel is drawn into the first partial channel by the Venturi effect.

In particular, the temperature of the compressible medium flowing in the second partial channel can be increased by the heating element so that the temperature of the heated compressible medium is higher than the temperature of the compressible medium flowing through the first partial channel in the first flow channel section.

In the mouth region and the adjoining second flow channel section, the heated compressible medium from the second partial channel mixes with the compressible medium from the first partial channel. In addition, as in the previous embodiment, the flow channel can have a cross-sectional area that progressively increases in the flow direction. According to this embodiment, the flow channel is annular.

In particular, due to the continuously increasing cross-sectional area of the flow channel in the second flow channel section, the pressure in the flow channel is increased by the diffuser effect as well as by the heat input, so that the flow velocity in the flow channel remains constant or can even increase. The heated compressible medium, which leaves the flow channel through an outlet opening in the area of the outlet, is used to drive the driven impeller.

According to an embodiment, the driven impeller can be coupled to the output shaft to operate a generator. In particular, the driven impeller may be coupled to a generator via an output shaft. According to an embodiment, the driven impeller includes an output shaft for operating the generator. The output shaft can be set into a rotational movement by means of the driven impeller when the compressible medium flows through the driven impeller. The compressible medium flows through the driven impeller. The driven impeller has guide elements, for example guide vanes, which are set into a rotational movement about the longitudinal axis of the output shaft by the flowing compressible medium when the compressible medium flows through the driven impeller.

According to an embodiment, the input shaft and the output shaft in particular have no mechanical connection to each other. The drive shaft and the output shaft are not coupled via a coupling mechanism. Thus, the drive shaft and the output shaft are mechanically decoupled.

The drive shaft can perform a rotational movement about the drive axis. The output shaft can perform a rotational movement about the output axis. The drive axis and the output axis can lie on a common straight line, i.e., the drive shaft and the output shaft can be arranged coaxially to each other. However, the drive axis and the output axis can also be arranged offset from each other, for example parallel to each other. The drive axis and the output axis can also include an angle to each other that is not equal to 180 degrees. The drive axis and the output axis can also coincide with the longitudinal axis of the drive unit.

According to an embodiment, the drive impeller can be set into a rotational movement by means of a starting device, at least in a run-in phase. The starting device can comprise a compressor for the compressible medium. In particular, a compressor may be arranged upstream of the drive impeller. The compressor can in particular comprise a fan.

According to an embodiment, a circulation device for the compressible medium is provided so that the compressible medium can be recirculated. In particular, the circulation device includes a return line so that the circulation device is in fluid communication with the flow channel. In particular, the return line can extend from the fluid space in which the output impeller is located to the inlet channel, which is located upstream of the input impeller. Thus, the return line extends from the outlet to the inlet. The return line can be arranged in a housing of the drive unit configured as a double casing. The return line extends at least from the driven impeller to the drive impeller. According to an embodiment, the return line can be configured as an annular channel. According to an embodiment, the return line can comprise at least one pipeline.

According to an embodiment, the flow channel extends from an inlet to an outlet. The drive impeller is located upstream of the inlet. The driven impeller is located downstream of the outlet. The drive impeller is received in a fluid space for the drive impeller into which the inlet line and the return line, if any, may discharge. The fluid space for the drive impeller is connected to the inlet into the flow channel. If a return line is provided, a side channel can be provided from the fluid space for the drive impeller or from the flow channel, which serves as an outlet channel for the compressible medium that is no longer required.

According to an embodiment, the flow body has a profiling, wherein the profiling can be helical or spiral.

According to an embodiment, the drive shaft comprises a substantially conical end forming a tip. When the drive shaft is arranged vertically, the tip can rest on a bottom plate of the housing, in which inlet openings are provided for the compressible medium flowing from the inlet channel into the drive impeller.

According to an embodiment, the flow channel can be heated. This increases the suction effect so that the flow velocity of the heated compressible medium flowing through the flow channel can be increased, in particular in the second flow channel section. When a heated compressible medium is used, the rotational speed of the output shaft can be increased and, consequently, the electrical power that can be generated by the generator can be increased. In particular, the housing can include a heating element or a channel for a heat transfer fluid.

A method of operating a drive unit comprises the following method steps. The drive unit comprises a housing, a flow channel for a compressible medium, a drive impeller and a driven impeller. The flow channel is disposed in the housing, the flow channel extending from the drive impeller to the driven impeller. The drive impeller is rotated by compressible medium, the compressible medium flowing through the drive impeller into the flow channel. The flow channel contains an inlet through which the compressible medium can enter the flow channel. The flow channel contains an outlet through which the compressible medium can exit the flow channel. When the compressible medium leaves the flow channel, it flows through the driven impeller. The driven impeller is set in rotational motion by the flowing compressible medium. The driven impeller contains an output shaft which is non-rotatably connected to the driven impeller. When the driven impeller performs a rotational movement, the output shaft rotates with it. The output shaft can, for example, drive a generator for producing electrical energy.

According to a method variant, the drive impeller sets a drive shaft in rotational motion, which in turn sets a driven impeller in rotational motion, the drive impeller and the driven impeller being connected via the drive shaft. The drive shaft may extend through a bore in the flow body. The drive shaft may be rotatably mounted in the bore so that it can perform a rotational movement relative to the flow body.

According to each of the method variants, the flow channel can contain a flow body, wherein the compressible medium flowing through the flow channel flows around the flow body, The flow body is arranged between the drive impeller and the driven impeller. The flow body is stationary, i.e., it is not rotatable with the drive shaft, the output shaft, the drive impeller or the driven impeller.

According to a method variant, the drive impeller is rotatably mounted in the housing, in particular rotatably mounted in the flow body on a drive shaft. When a compressible medium flows through the drive impeller, it is set in rotary motion. The rotational movement of the drive impeller causes the compressible medium to flow into the flow channel. The compressible medium flows through the flow channel from the inlet to the outlet. When the compressible medium has flowed through the flow channel, it hits the driven impeller and sets it in rotary motion. The output shaft is non-rotatably connected to the driven impeller. The output shaft is rotatably mounted in the housing, in particular rotatably mounted in the flow body. According to this method variant, the drive impeller and the driven impeller are not coupled to each other via the drive shaft. The output shaft is driven to operate a generator for producing electrical energy, with the output shaft being set into a rotational movement when the compressible medium flows against the driven impeller, which is connected to the output shaft in a rotationally fixed manner.

A method of operating a system comprising a drive unit according to any one of the preceding embodiments comprises a heat exchanger to which a heated heat transfer fluid is supplied from a heat accumulator to heat the compressible medium, so that the compressible medium is heated by means of the heat transfer fluid. The compressible medium is converted into a heated compressible medium by supplying the heat energy. The heated compressible medium is fed to the drive unit. According to this variant, the drive unit is operated with the heated compressible medium, whereby higher flow velocities and thus a higher rotational speed of the drive shaft and the output shaft can be achieved. The rotational speed of the drive impeller and the driven impeller can be increased.

According to each of the method variants, the flow velocity in the flow channel can be increased to increase the speed of the output shaft and to increase the power of a generator operable by the output shaft.

By means of the flow body, the flow cross-section of the flow channel can be designed in such a way that the flow velocity of the compressible medium flowing through the flow channel increases or decreases in the flow channel. According to an embodiment, the flow cross-section of the flow channel continuously decreases in the flow direction so that the flow velocity of the compressible medium in the flow channel increases. According to an embodiment, the flow cross-section of the flow channel of the compressible medium continuously increases in the flow direction, so that the flow velocity of the compressible medium in the flow channel decreases. In particular, the flow body is configured in such a way that the flow cross-section of the flow channel in the flow direction of the compressible medium is continuously reduced by the flow body, so that the flow velocity of the compressible medium in the flow channel increases. According to an embodiment, the flow body is configured in such a way that the flow cross-section of the flow channel continuously increases in the flow direction of the compressible medium, so that the flow velocity of the compressible medium in the flow channel decreases. According to an embodiment, the flow cross-section, i.e., the cross-section through which fluid flows, of the flow channel decreases continuously downstream of the inlet in the flow direction of the compressible medium and then increases continuously.

In particular, the flow channel can pass a heating element so that the compressible medium in the flow channel can be heated.

The flow channel can comprise a plurality of channel portions. For example, a first channel portion may be provided in which the compressible medium is not heated or is heated only slightly as it flows through the first channel portion. A second channel portion is provided in which the compressible medium flowing through the second channel portion is heated by means of the heating element. The second channel portion can open into the first channel portion downstream of the heating element, so that the heated compressible medium mixes with the compressible medium. Thus, the temperature of the compressible medium flowing in the second channel portion is increased by the heating element so that the temperature of the compressible medium in the second channel portion is higher than the temperature of the compressible medium in the first channel portion.

The first channel portion and the second channel portion run side by side and form a first flow channel section. The first channel portion and the second channel portion open into each other in the mouth region. Downstream of the mouth region, a collecting channel adjoins, which forms a second flow channel section. If, in addition, the flow cross-section of at least one of the first and second channel portions decreases upstream of the mouth region and the flow cross-section of the flow channel increases downstream of the mouth region, the compressible medium flowing in the second channel portion can be drawn into the second flow channel section adjoining the first channel portion by the Venturi effect. However, the flow velocity of the compressible medium is not only increased by the Venturi effect, but also by mixing with the heated compressible medium.

When the cross-section of the flow channel increases in the second flow channel section, the combined effect of the diffuser effect and heat input results in increased pressure and flow velocity of the heated compressible medium, so that the speed of the driven impeller can be several times the speed of the drive impeller.

The temperature of the compressible medium amounts to a maximum of 200 degrees Celsius, in particular a maximum of 120 degrees Celsius. The drive unit is also suitable for operation at temperatures of maximum 90 degrees Celsius.

For operating temperatures of a maximum of 120 degrees Celsius, plastics can also be used as materials for the housing or housing components, which enables a particularly cost-effective design of the drive unit. In addition, each of the components can be manufactured using an additive manufacturing process.

The pressure of the compressible medium is a maximum of 10 bar. In particular, the pressure is in the range of 0.5 to 5 bar. The compressible medium can contain air or consist of air.

A system for generating electrical energy includes a drive unit according to any of the preceding embodiments. The system can include a plurality of drive units, in particular the system, can include at least 2 drive units. In particular, the drive unit can be of modular design. The drive unit can be temporarily connected to convert thermal energy into electrical energy or can be operated continuously to convert thermal energy into electrical energy.

In particular, the system can include a heat exchanger, wherein a heated compressible medium is obtainable from the compressible medium by means of the heat exchanger. According to an embodiment, the system comprises a heat accumulator for providing a heated compressible medium, wherein the heat accumulator is replenishable from an energy source, in particular a heat source, selected from the group consisting of a solar cell, a photovoltaic panel, an internal combustion engine, a fuel cell, a fossil fuel burner element, a wind turbine.

In addition to a drive unit according to one of the preceding embodiments, a system for generating electrical energy can comprise a heat accumulator. The heat accumulator contains a heated heat transfer fluid, which can be supplied to the heat accumulator from a heat source. The heat source can be provided for heating the heat transfer fluid such that the heat transfer fluid is convertible into a heated heat transfer fluid. The heated heat transfer fluid can be stored in the heat accumulator. The heated heat transfer fluid can be supplied from the heat accumulator to a heat exchanger by means of suitable fluid lines. The heat exchanger is configure to heat a compressible medium by means of the heated heat transfer fluid, whereby a heated compressible medium can be generated. The heated compressible medium can be supplied to the drive unit. The drive unit can be driven by the heated compressible medium. The heat transfer fluid can comprise water or an oily fluid or a molten salt. Such a system can provide a production power of at least 50 kW at a voltage of 400 V and a frequency of 50 Hz. The system does not produce any harmful emissions, in particular no CO₂, no nitrogen oxides (NOX) and no fine dust, since the compressible medium is not subject to any material change. According to an embodiment, the drive shaft is driven by means of a starting device, in particular an electric starter, which in turn can be supplied by a 24V battery. However, such a starting device is only required for the start-up phase, i.e., for a short period of maximum 10 minutes, in order to set the drive shaft in rotary motion and to generate an input flow of the compressible medium.

The compressible medium can be heated. Heating of the compressible medium enables its expansion to a larger volume, which is a multiple of the volume of the input flow. If expansion is not possible, the pressure of the compressible medium in the flow channel increases accordingly, so that a compressed compressible medium is obtained. The compressed compressible medium is directed to the driven impeller(s) coupled to the output shaft. The driven impellers are set in rotational motion by means of the compressible medium, so that the output shaft can perform a corresponding rotational motion. By means of the output shaft, a generator can be operated to produce electricity. When the output shaft is set into a rotational movement, electricity can thus be generated by means of the generator by means of the system according to the invention.

Such a system according to any one of the embodiments described above is preferably used for utilizing the heat of waste heat streams which, due to low temperatures, pressures or low throughputs, could not be economically utilized for energy recovery so far. In addition, such a system can be used at any location that cannot be connected to a central power grid.

The system does not produce any emissions, in particular no CO₂. The drive unit can consist of recyclable components which, in particular, do not have any components containing elements from the rare earth group, so that no special precautions need to be taken for the disposal of a drive unit which is taken out of service.

The system can be accommodated in a commercially available shipping container, for example, contained in a container of approximately 6 meters (20 feet) overall length. Such a container can, for example, be configured as a 20-foot shipping container with the following dimensions: 5.66 m×2.07 m×2.2 m. The required floor space is 11.7 m². This results in a required footprint of 11.7 m² and a height of 2.2 m. The weight of such a system is not more than 10 000 kg. The shipping container is used as a transport container for a system in maritime and inland shipping and combined transport by road and rail. Once the container is installed, the plant can start operation for the production of electric energy. If available, the system can also be connected directly to the local power grid or used as a stand-alone power supply in remote locations, as required. The container contains the system, including a heat accumulator and one or more drive units, as well as a control unit, which may include a monitoring unit. The control unit permanently monitors the operation of the plant, detects faults at an early stage and, as far as possible, rectifies them independently. If a monitoring unit can be used, maintenance work can be carried out preventively so that no interruption of operation is required.

A plurality of drive units with the same or different production capacity can be coupled together in a modular fashion so that a scalable system of any production capacity is available. For example, if one drive unit provides 1000 W of power, Z units can provide essentially Z times 1000 kW. In particular, Z can be an integer from 1 to 100. Scaling of power can thus be essentially lossless, apart from usual line losses.

The container containing the system can be delivered to any location by water, road or rail, as its dimensions comply with the international standard. Electricity production can run 24 hours a day, especially if heat sources are provided, by means of which thermal energy can be obtained from renewable energy sources, as well as appropriate heat accumulators, which provide thermal energy to the drive unit when the energy source is temporarily unavailable. The service life of a system can be 30 years. Thus, electricity can be generated, stored, consumed or fed into the local grid continuously 365 days for 24 hours for a period of at least 30 years in the smallest possible space.

The system can be placed at any location that can be reached by truck, ship, train or helicopter. The system is taken out of the container at the place of installation and can produce electricity immediately. If the system is operated with solar cells, the required footprint for the nacelle and the solar cells is only 80 m², including any gaps. Interstitial spaces can occur, for example, when umbrella-shaped solar cells are used.

In the following, the drive unit according to the invention is illustrated by means of some embodiments. It is shown in

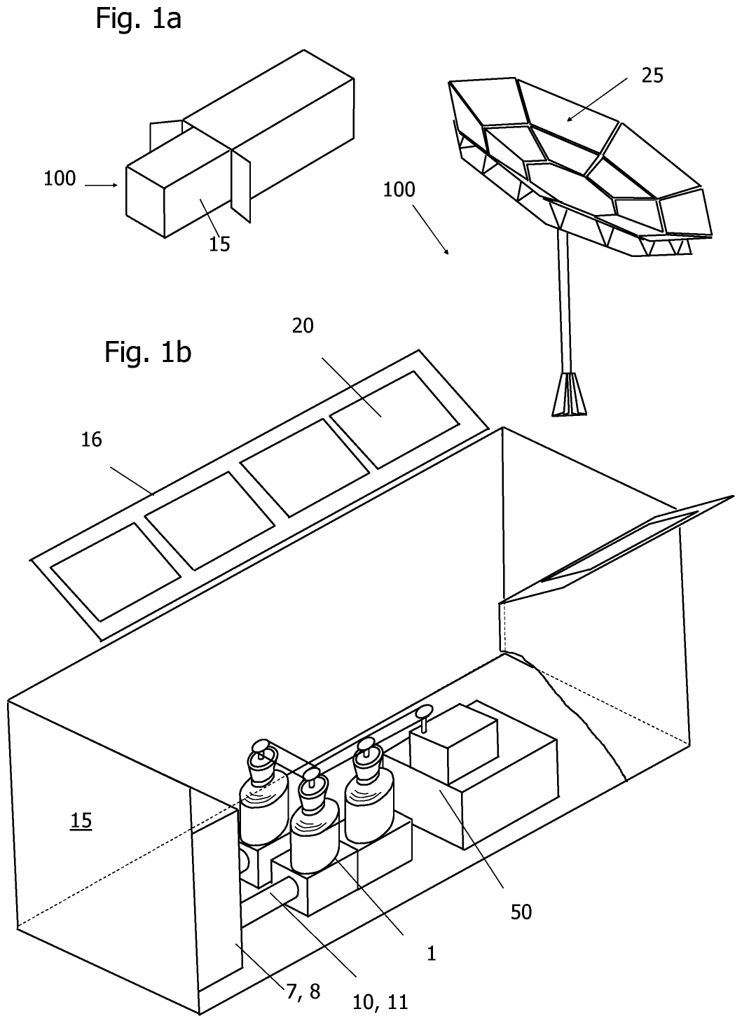

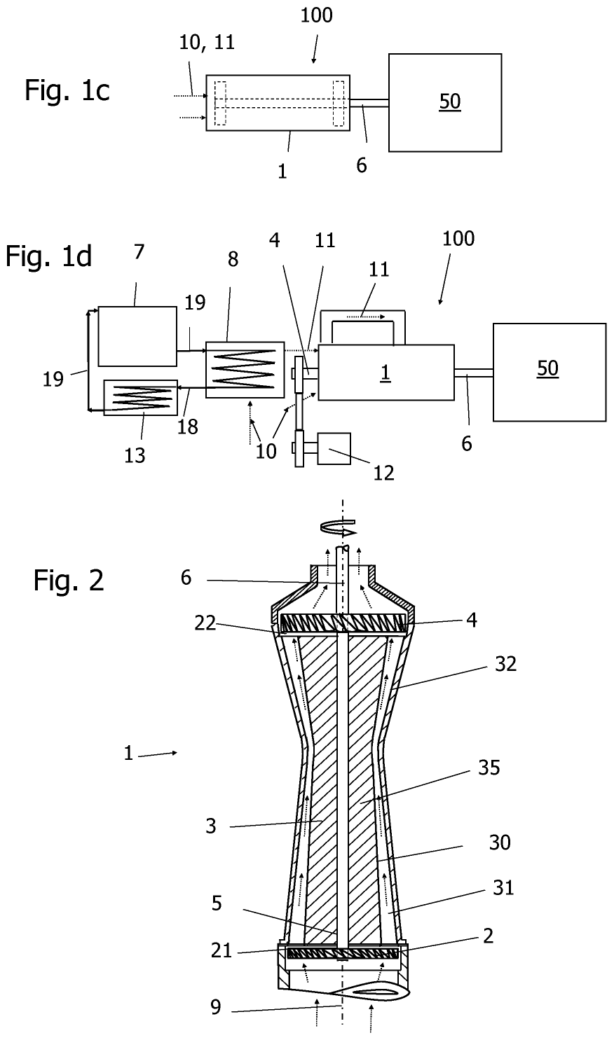

FIG. 1a a schematic representation of a system according to one of the embodiments,

FIG. 1b a system containing a plurality of drive units,

FIG. 1c a schematic of a first variant of a system comprising a drive unit according to one of the embodiments,

FIG. 1d a schematic of a second variant of a system comprising a drive unit according to one of the embodiments,

FIG. 2 a longitudinal section of a drive unit according to a first embodiment,

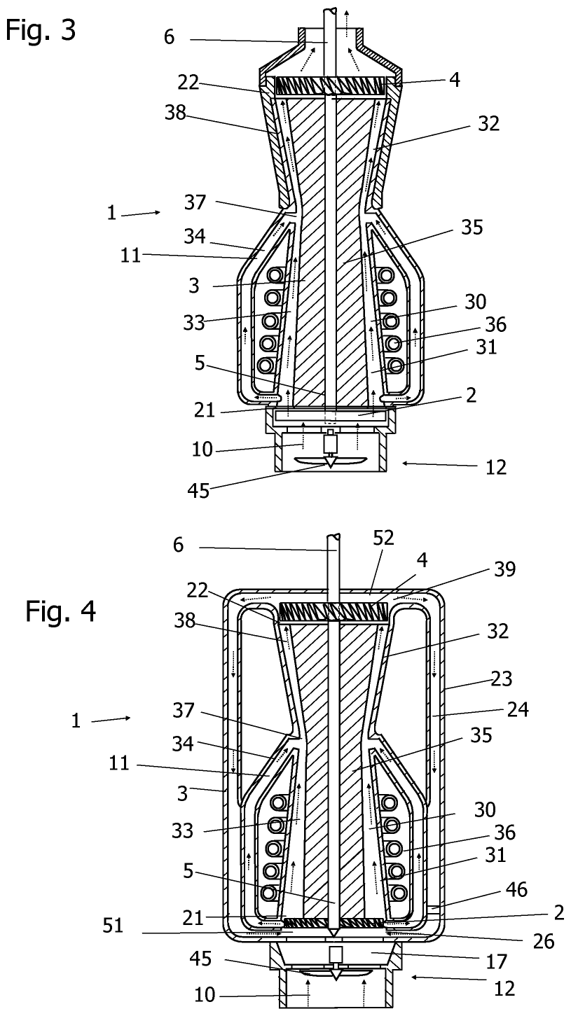

FIG. 3 a longitudinal section of a drive unit according to a second embodiment,

FIG. 4 a longitudinal section of a drive unit according to a third embodiment,

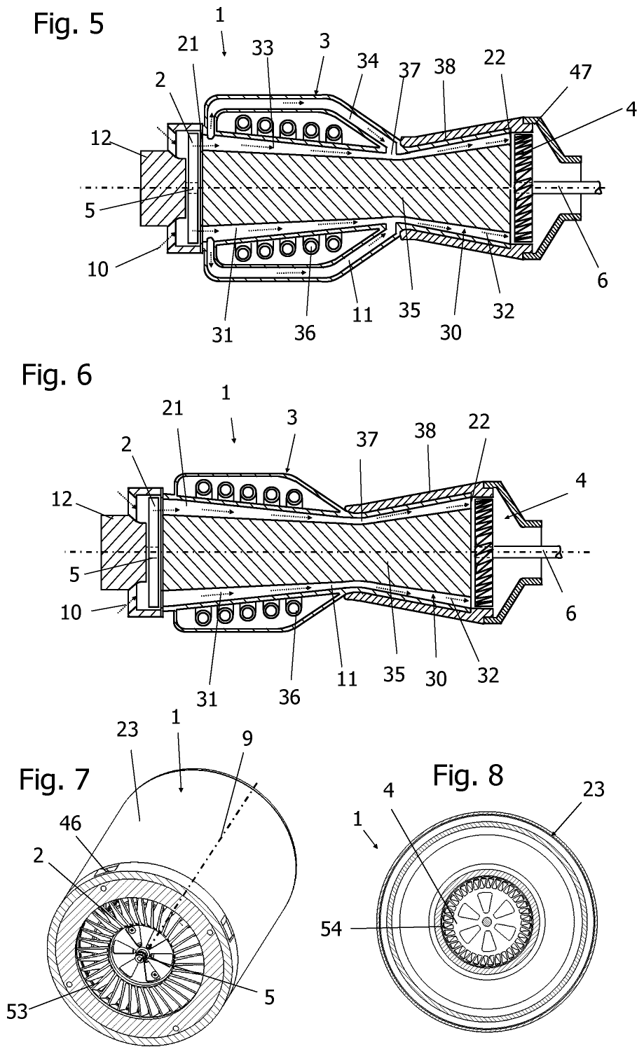

FIG. 5 a longitudinal section of a drive unit according to a fourth embodiment,

FIG. 6 a longitudinal section of a drive unit according to a fifth embodiment,

FIG. 7 a radial section of a drive unit according to a sixth embodiment which shows the drive impeller,

FIG. 8 a radial section of a drive unit according to the sixth embodiment which shows the driven impeller,

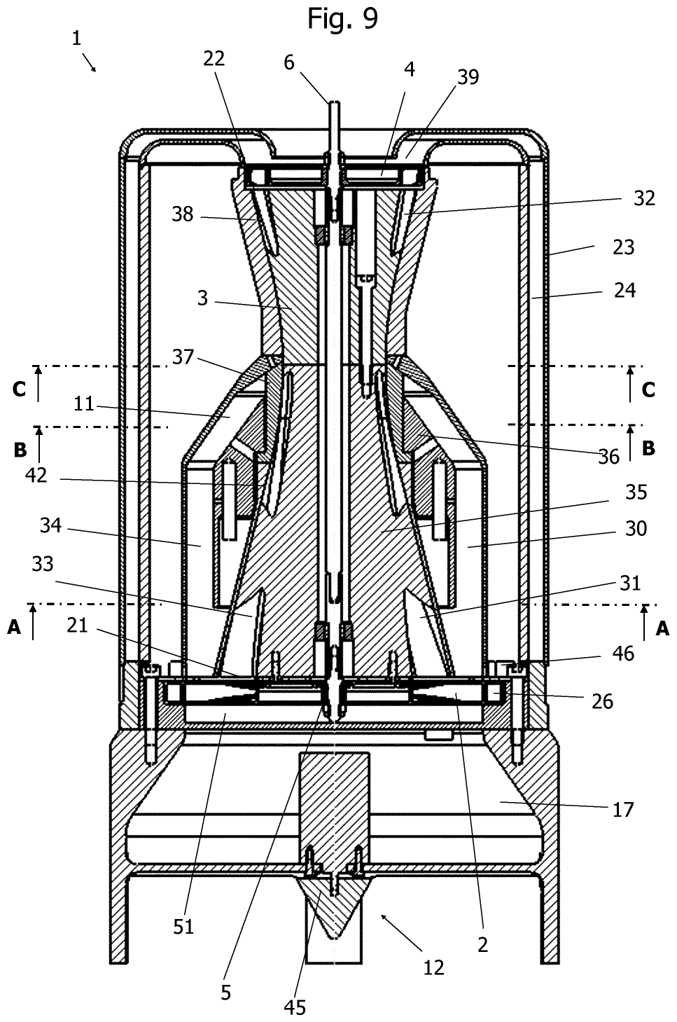

FIG. 9 longitudinal section of a drive unit according to the sixth embodiment,

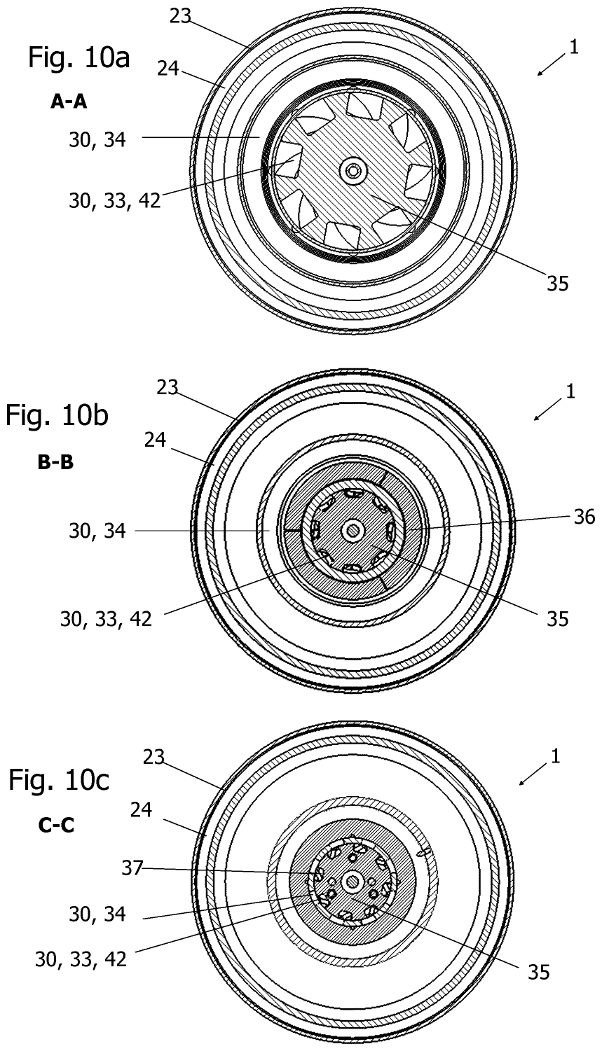

FIG. 10a a radial section of the flow channel in the first flow channel section of the drive unit according to the sixth embodiment,

FIG. 10b a radial section of the flow channel with a heating element of a drive unit according to the sixth embodiment,

FIG. 10c a radial section of a drive unit according to the sixth embodiment, showing the mouth region,

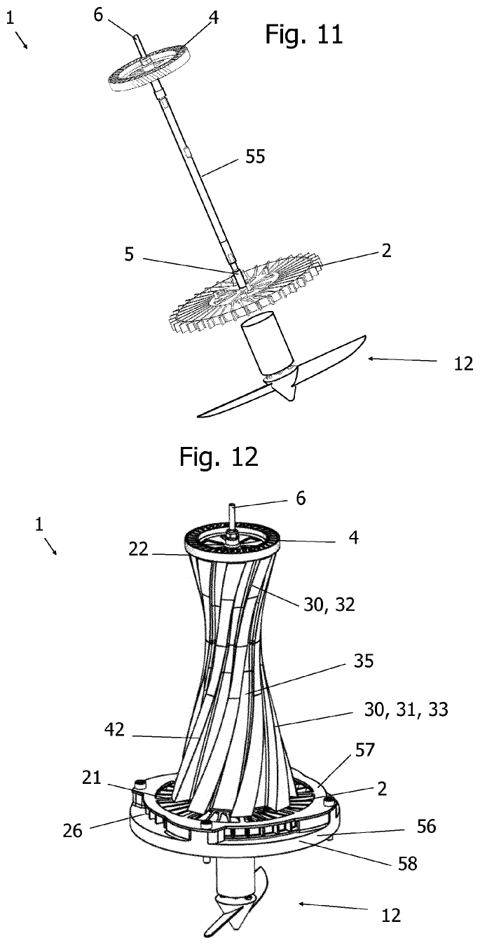

FIG. 11 a view of the drive elements of the drive unit according to the sixth embodiment example,

FIG. 12 a view of the flow channel of the drive unit according to the sixth embodiment,

FIG. 13 an embodiment of a heat accumulator for a system according to any of the preceding embodiments,

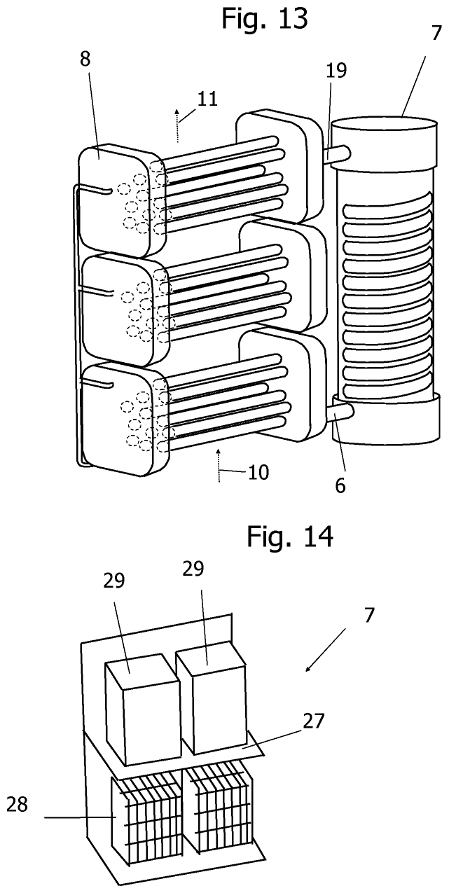

FIG. 14 an embodiment of a heat source for a system according to any of the preceding embodiments.

FIG. 1a shows a system 100 for generating electrical energy, which is partially accommodated in a commercially available transport container. The system 100 is accommodated in the transport container and can thus be transported in the transport container by road, by water, by air or by means of rail vehicles. The system 100 includes a plurality of system components housed in a nacelle 15, which is closed for transport after the system components are installed. Thus, the system components remain secured and protected from any unauthorized access during transportation in the nacelle 15. After commissioning of the system 100 at the place of use, the system 100 is locked by the producer in such a way that the user or operator of the system 100 is denied any access to the interior of the nacelle 15. The user or operator of the system shall not be involved with the maintenance or servicing of the system 100. The producer of the system 100 shall continuously monitor and maintain the system throughout its life. The producer shall be able to monitor the operating status of any system 100 in use at any time, including, but not limited to, remote maintenance.

The nacelle 15 and/or each of the system components may be equipped with identification elements which make it possible to check at any time whether all the system components are present, whether they are the system components installed in the producer's factory, and whether the system components have been modified at any time by unauthorized intervention. The nacelle 15 may be equipped with a GPS transmitter so that the exact location of each nacelle 15 can be verified by the producer at any time. In particular, the GPS sensor can be used to provide feedback to the producer as soon as the nacelle 15 or any of the system components are moved. In particular, at least the most important system components can be equipped with position sensors. The position sensors can determine the position of the relevant system component in the nacelle 15 or determine the position of two or more system components relative to each other. By using the position sensors, the exact position of the system components in the nacelle 15 can be determined with an accuracy of less than 10 cm, preferably less than 10 mm, particularly preferably in a range of at most 5 mm. The position sensors can be coupled with monitoring elements that monitor the position of the system components in the nacelle 15. As soon as a system component therefore moves more than 10 cm, in particular more than 10 mm, from its nominal position, an alarm can be triggered. The producer can immediately check whether this is an authorized change in the position of the system component, for example for maintenance or repair of the same, or whether there has been unauthorized interference with the nacelle 15 and immediately take suitable measures to prevent damage to persons or the system.

The system has a plurality of photovoltaic panels 20 on the inside of a hinged roof 16. The roof 16 is used to keep the nacelle 15 closed when energy cannot be generated by the photovoltaic panels 20 or when the interior of the nacelle 15 must remain closed due to weather conditions or for safety reasons. The photovoltaic panels 20 can represent an embodiment of a device for generating heat, that is, a heat source 13, which can be stored in the heat accumulator 7. The heat accumulator 7 can provide heated compressible medium 11 for the operation of the drive unit 1.

According to FIG. 1b, a solar cell 25 can also be provided to form a heat source 13. According to FIG. 2, a plurality of solar cells 25 can also be used. In particular, the solar cell 25 can be configured as a flat plate collector for heating the heat transfer fluid. The flat plate collector can comprise a double web hollow chamber plate. In particular, the double web hollow chamber plate can comprise a transparent material, such as acrylic glass or polycarbonate. According to an embodiment, the flat plate collector, in particular the double web hollow chamber plate, can include an absorber body. The absorber body may be formed by a plurality of dimples in the double web hollow chamber plate. According to an embodiment, electrical energy may be used to operate the starting device instead of thermal energy. In particular, the electrical energy may be provided by means of the photovoltaic panel 20. The electrical energy may also be temporarily stored via energy storage devices until needed.

FIG. 1b shows an embodiment for a system 100, wherein the roof 16 of the nacelle 15 is partially open. According to this embodiment, the open roof 16 contains a plurality of photovoltaic panels 20 for generating thermal energy, for example. The roof 16 can remain closed for steady state operation of the system. According to an embodiment, the photovoltaic panels 20 can be disassembled from the roof and used in another location to provide additional energy in the operating state of the system, for example by means of the screen elements also shown.

In particular, the system 100 can be locked in such a way that it remains accessible only to the producer with access authorization, in particular by authentication, for example by entering a corresponding access code. This can prevent any manipulation by a user or operator and, in particular, any damage to the system components. A risk of injury can also be excluded for ordinary operation. When the system 100 is put into operation at the destination for the first time, this is done by the producer's personnel responsible for commissioning. Once the system 100 can be operated without interference, the nacelle 15 can be sealed so that any unwanted access can be excluded. In particular, the nacelle 15 or each of the system components can be equipped with RFID identification elements. These identification elements can already be installed in each of the system components when the system 100 is manufactured.

FIG. 1c shows a schematic representation of a system 100 with a drive unit 1 according to a first embodiment. A generator 50 is drivable by means of an output shaft 6 for generating electrical energy, wherein the output shaft 6 can be set into a rotational movement by the drive unit 1. The drive unit 1 is operable with a compressible medium 10 or a heated compressible medium 11.

FIG. 1d shows a schematic representation of a system 100 with a drive unit 1 according to a second embodiment. The system 100 contains an optional heat accumulator 7, an optional heat exchanger 8 and the drive unit 1. As in FIG. 1c, a generator 50 for generating electrical energy can be driven by means of an output shaft 6, wherein the output shaft 6 can be set in a rotational movement by the drive unit 1. The heat accumulator 7 contains a heated heat transfer fluid 19, which can be supplied to the heat accumulator 7 from a heat source 13. The heat source 13 is provided to provide a heated heat transfer fluid 19 and to replenish the heat accumulator 7. The heated heat transfer fluid 19 is used in the heat exchanger 8 to heat a compressible fluid 10 flowing through the heat exchanger 8. The heat accumulator 7 is fluidly connected to a heat exchanger 8 for heating a compressible medium 10 by means of the heated heat transfer fluid 19, so that a heated compressible medium 11 can be generated in the heat exchanger 8 from a compressible medium 10. The drive unit 1 is operable with the compressible medium 10 or the heated compressible medium 11. The heat transfer fluid 18 leaving the heat exchanger 8 is heated in the heat source 13, which may also be a heat exchanger, to obtain the heated heat transfer fluid 19.

A starting device 12 can be provided for starting up the drive unit 1. The starting device 12 can be coupled to the drive shaft 4. For example, an electric starter can be provided. Instead of the starting device 12, a compressor can also be provided, for example a fan.

FIG. 2 shows a section through a drive unit 1 according to a first embodiment. The drive unit 1 for a generator according to the present embodiment comprises a housing 3, a flow channel 30 for a compressible medium, a drive impeller 2 and a driven impeller 4. The flow channel 30 is arranged in the housing 3. The flow channel 30 extends from the drive impeller 2 to the driven impeller 4. The drive impeller 2 is rotatably mounted on a drive shaft 5 and the driven impeller 4 is rotatably mounted on an output shaft 6. At least one of the drive shafts 5 and the output shafts 6 is rotatably mounted in the housing 3. The housing 3 contains a flow body 35, wherein the flow body 35 is arranged between the drive impeller 2 and the driven impeller 4. In particular, the flow body 35 may extend from the drive impeller 2 to the driven impeller 4. In particular, the flow body 35 is arranged within the flow channel 30. The flow body 35 can form, at least in sections, an inner internal wall of the flow channel 30. The flow body 35 shapes the flow cross section of the flow channel 30 in such a way that the flow velocity of the compressible medium in the flow channel 30 can be changed, in particular the flow velocity of the compressible medium can increase or decrease. In particular, the flow cross-section of the flow channel 30 of the compressible medium 10, 11 may continuously decrease in the flow direction so that the flow velocity of the compressible medium 10, 11 in the flow channel 30 increases. According to an embodiment, the flow cross-section of the flow channel 30 of the compressible medium 10, 11 increases continuously in the flow direction so that the flow velocity of the compressible medium 10, 11 in the flow channel 30 decreases. In particular, the flow body 35 is configured in such a way that the flow cross-section of the flow channel 30 is continuously reduced in the flow direction of the compressible medium 10, 11 by the flow body 35, so that the flow velocity of the compressible medium 10, 11 in the flow channel 30 increases. According to an embodiment, the flow body 30 is formed such that the flow cross section of the flow channel 30 continuously increases in the flow direction of the compressible medium 10, 11 so that the flow velocity of the compressible medium 10, 11 in the flow channel 30 decreases.

According to the embodiment shown in FIG. 2, the compressible medium 10, 11 is supplied to the drive impeller 2 in the operating state of the drive unit 1. The drive impeller 2 is set into a rotational motion by the compressible medium. In particular, the drive impeller contains guide vanes for this purpose, which are arranged at an angle to the flow direction of the inflowing compressible medium 10, 11, which can be between 10 degrees and 80 degrees. According to the present embodiment, the compressible medium 10, 11 flows upstream of the drive impeller 2 essentially parallel to the longitudinal axis 9 of the drive unit 1. By means of the drive impeller 2, the drive shaft 5 can be set into a rotational motion. The compressible medium 10, 11 flows from the drive impeller into the flow channel 30.

According to the present embodiment, the flow channel 30 includes a first flow channel section 31 and a second flow channel section 32 extending between the drive impeller 2 and the driven impeller 4. The second flow channel section 32 connects to the first flow channel section 31. In particular, the compressible medium 10, 11 can flow through the flow channel 30 from bottom to top. That is, according to this embodiment, the inlet 21 is arranged below the outlet 22. In particular, the longitudinal axis 9 of the drive unit 1 can be arranged substantially vertically. The vertical arrangement has the advantage that the flow direction, in particular of a heated compressible medium 11, is from bottom to top. However, the drive unit can of course also be operated in the same way with a non-vertical arrangement.

According to FIG. 2, the flow body 35 is located in the first flow channel section 31 and in the second flow channel section 32. According to the present embodiment, the flow body 35 in the first flow channel section 31 is formed as a body with a conical shape. In each case, the flow body 35 forms the inner wall of the flow channel 30. The flow channel 30 is thus formed as an annular channel surrounding the flow body 35.

According to the embodiment example shown in FIG. 2, the diameter of the cone in the first flow channel section 31 decreases in the flow direction. According to the present embodiment, the flow body 35 in the second flow channel section 32 is formed as a body with a conical shape. The diameter of the cone increases in the second flow channel section 32 in the flow direction. Thus, the flow channel 30 has a flow cross-section progression in the first flow channel section 31, wherein the flow cross-section decreases as viewed from the inlet 21 toward the outlet in the first flow channel section 31. According to the present embodiment, the flow body forming the cone tapers in the direction of the second flow channel section 32. In the second flow channel section 32, the flow channel 30 has a course of the flow cross section, wherein the flow cross section, viewed from the first flow channel section 31, increases in the direction of the outlet 22 in the second flow channel section 32.

The flow body 35 can have a plurality of profilings 41, as shown in the embodiment according to FIG. 12, which are arranged on its outer surface, which forms the inner internal wall of the flow channel 30. In particular, at least one of the first and second flow channel sections 31,32 of the flow body 30 can be formed as a cone which can have profilings 41. The fluid flow is set into a spiral motion in the first flow channel section 31 and second flow channel section 32 by the deflecting effect of the guide elements of the drive impeller 2, which can be reinforced by a profiling 41. In addition, one or more guide elements can be arranged on the outer inner wall of the flow channel 30, by means of which the fluid flow can be directed in such a way that a swirl can be impressed on the compressible medium at least in a partial region of the first flow channel section 31 or in the second flow channel section 32. The incident flow to the driven impeller 4 can take place essentially without loss if the flow direction corresponds to the optimum incident flow angle for the guide vanes of the driven impeller 4 and therefore enables optimum incident flow to the guide vanes of the driven impeller 4.

By using a cone tapering in the direction of flow in the first flow channel section 31 and the adjoining second flow cross-section 32 of the flow channel 30 as well as the deflection of the fluid flow when flowing through the driven impeller 4, the compressible medium 10, 11 can be accelerated in the first flow channel section, pressure recovery can take place in the second flow channel section and can flow into the driven impeller. The driven impeller 4 can include guide vanes whose orientation is adapted to the flow direction of the compressible medium 10, 11. In particular, the angles of the guide vanes 53 of the drive impeller 2 and the guide vanes 54 of the driven impeller 4 can differ according to this embodiment.

The expansion of the compressible medium 10, 11 in the second flow channel section 32 and, if necessary, a further expansion in the driven impeller 4 can generate an additional suction effect at the upstream of the inlet 21, so that according to this design no additional blower or compressor is required for the operation of the drive unit 1.

FIG. 3 shows a second embodiment of a drive unit 1. The same reference signs are used for the same or similarly acting elements as in the previous embodiments. According to this embodiment, the flow channel 30 divides downstream of the drive impeller 2 into a first channel portion 33 and a second channel portion 34. In particular, the mouth region 37 may be located at a point of the flow channel that is between the inlet 21 and the outlet 22. If the flow channel 30 comprises a first flow channel section 31 and a second flow channel section 32, the second channel portion 34 may in particular open into the first channel portion 33 at a mouth region 37 in which the transition from the first flow channel section 31 to the second flow channel section 32 is located.

The compressible medium 10, 11 flowing in the second channel portion 34 is drawn into the first channel portion 33 by the Venturi effect.

The heating element 36 can, for example, be configured as a heating coil or heating jacket, but it can also be configured as an electrical heating element. By means of the heating element 36, in particular the second channel portion 34 flowing around the heating element 36 or the compressible medium 10 flowing in the second channel portion 34 is heated, so that a heated compressible medium 11 is obtained.

The heated compressible medium 11 mixes with the compressible medium 10 flowing through the first channel portion 33 downstream of the mouth region 37. Consequently, the temperature of the heated compressible medium 10, 11 flowing through the second flow channel section 32 is higher than the temperature of the compressible medium 10 flowing through the first channel portion 33 in the first flow channel section 31. Thus, the pressure in the second flow channel section 32 increases not only due to the diffuser effect of the widening flow channel 30, but also due to the higher temperature of the heated compressible medium.

Additionally, the flow channel 30 may be surrounded by a jacket element 38 in the second flow channel section 32. The jacket element 38 can provide thermal insulation or can include a heating device to further heat the heated compressible medium 11.

The arrangement of the heating element(s) 36, 38 as well as the course of the cross-sectional area of the flow channel 30 can be combined in any way to obtain the optimum flow velocity as well as the optimum inflow angle for the driven impeller 4 for each compressible medium. The embodiments described above and below represent only exemplary combinations of the possible arrangement of the flow channels and the heat input. Depending on the thermodynamic state of the compressible medium 10, 11 in the inlet as well as its volumetric flow rate, the optimum configuration of the drive impeller 2, the driven impeller 4, the cross-sectional areas of the flow channels 30 as well as the heat input by one or more heating elements 36 can be found to achieve the best possible efficiency for the generator 50 by combining the features of the embodiments. In particular, due to the continuously increasing cross-sectional area of the flow channel 30 in the second flow channel section, the pressure in the flow channel 30 is increased by the diffuser effect as well as by the heat input, so that the flow velocity in the flow channel 30 can remain constant or even increase. The heated compressible medium 11, which leaves the flow channel 30 in the area of the outlet 22 through an outlet opening, is used to drive the driven impeller 4.

The driven impeller 4 is connected to the generator 50 via an output shaft 6. According to this embodiment, the output shaft 6 is formed integrally with the drive shaft 5, so that the drive impeller 2 and the driven impeller 4 are coupled to each other. According to FIG. 9 or FIG. 11, the output shaft 6 may be coupled to the drive shaft via a coupling mechanism. In particular, the output shaft 6 can drive a generator 50 for generating electrical energy (not shown).

FIG. 3 also shows an embodiment for a starting device 12. According to an embodiment, the drive impeller 2 can be set into a rotational movement by means of a starting device 12, at least in a run-in phase. The starting device 12 can comprise a compressor for the compressible medium. In particular, a compressor 45 can be arranged upstream of the drive impeller. In particular, the compressor 45 can comprise a fan.

A starting device, for example an electric starter, can be provided to generate an initial rotational movement of the drive shaft 5 so that a flow of compressible medium 10, 11 is generated and thus the rotational movement of the output shaft 6 can be initiated via the driven impeller 2.

The starting device can switch off automatically after the fluid flow has stabilized, i.e., a continuous rotational movement of the drive impeller 2 or the drive shaft 5 takes place. In particular, during the starting phase, i.e., especially for generating the Venturi effect in the flow channel 30 (see FIGS. 3 to 5), the compressible medium 10, 11 can be heated by means of stored heat. Thus, the volume of the heated compressible medium 11 expands to a multiple of the volume of the compressible medium 10, whereby the driven impeller or impellers 4 are driven and the output shaft 6 is set into a rotational movement with the torque required for the operation of the generator.

For example, the electrical energy generated by means of the photovoltaic panel 20 according to FIG. 1b can be used as a starting aid for the start-up phase of the drive unit 1 or a plurality of drive units 1. For example, the drive shaft 5 can be driven by an electric starter which is powered by a 24V battery. Thus, within a short period of time, the drive shaft 5 of the drive unit 1 is set into a rotary motion so that a suction effect for the compressible medium 10, 11 can be generated by means of the drive impeller 5. When the compressible medium 10, 11 is heated, it may expand to several times its original volume. Due to the increase in volume and, if necessary, with optimized design of the flow channel(s) 30, the pressure of the compressible medium 10, 11 flowing through the drive unit 1 is increased so that the rotational movement of the driven impeller 6 can be initiated or increased so that a generator 50 for generating electrical energy can be driven via the output shaft 6.

FIG. 4 shows a longitudinal section of a drive unit according to a third embodiment. According to the present embodiment, the driven impeller 4 is located on the drive shaft 5. The drive shaft 5 extends from the drive impeller 2 through the housing 3 and may project beyond the driven impeller 4. According to this embodiment, the flow channel 30 has a continuously tapering first flow channel section 32, a mouth region 37 with a substantially constant flow cross-section, and a second flow channel section 32 in which the flow cross-section increases, in particular a continuously widening flow cross-section. The flow velocity of the compressible medium 10, 11 can be increased through the tapering flow channel section 32 before the compressible medium 10, 11 is mixed with the heated compressible medium 11, which enters the second flow channel section of the flow channel 30 from the second channel portion 34 into the mouth region 37. In the subsequent, continuously widening second flow channel section 32, the flow velocity of the heated compressible medium 11 decreases, whereby wall separation and thus losses due to the shape of the flow channel 30 are reduced.

According to the present embodiment, the drive unit 1 includes a circulation device 23 for the compressible medium 10, 11. The circulation device 23 is in fluid communication with the flow channel 30. In particular, the circulation device 23 can connect the outlet 22 to the inlet 21 for the compressible medium 10, 11.

Instead of the annular outlet 22 shown, a plurality of outlet elements could also be provided, which are configured, for example, as closed channels, in particular as pipes. According to an embodiment not shown, the outlet or outlets 22 can open into a common return line 24. The return line 24 can be in the form of a pipe, and can also be arranged in a spiral around the flow channel 30 and optionally the first and second flow channel sections 31, 32 or the first and second channel portions 33, 34. If reference is made below only to the flow channel 30, this reference is intended only for simplification, but in no way to exclude the possibility that embodiments comprising a plurality of flow channel sections 31, 32 and/or a plurality of channel portions can also comprise such a circulation device 23.

Thus, the circulation device 23 includes the return line 24 so that the circulation device 23 is in fluid communication with the flow channel 30. In particular, the return line 24 may lead from the fluid space 52 in which the driven impeller 4 is located to an inlet channel 17 which is located upstream of the drive impeller 2. The return line 24 may be arranged in a housing 3 of the drive unit 1, which is designed as a double casing. The return line 24 extends at least from the driven impeller 4 to the drive impeller 2 or from the fluid space 52, in which the driven impeller 4 is located, to the fluid space 51, in which the drive impeller 2 is located. According to an embodiment, the return line 24 can be configured as an annular channel. According to an embodiment, the return line can comprise at least one pipeline.

According to this and other embodiments, the flow channel 30 extends from the inlet 21 to the outlet 22. The drive impeller 2 is located upstream of the inlet 21. The driven impeller 4 is located downstream of the outlet 22. The drive impeller 2 is accommodated in a fluid space 51 for the drive impeller 2, into which the inlet line 17 and the return line 24, if present, can open. The fluid space 51 for the drive impeller is connected to the inlet 21 into the flow channel 30. If a return line 24 is provided, a side channel 46 can be provided from the fluid space 51 for the drive impeller or from the flow channel 30, which serves as an outlet channel for the compressible medium 10, 11 that is no longer required.

The return line 24 can extend around the flow channel 30, for example forming a double-walled housing 3. By means of the return line 24, the compressible medium 10, 11 passes from the outlet 22 to the inlet(s) 21. According to a variant not shown, the cross-section of the return line 24 through which the fluid flows can be at least partially variable. The return line 24 has at least one mouth opening 26 into the flow channel 30, which is arranged in the vicinity of that of the inlet 21. In particular, the mouth opening 26 may be arranged upstream of the inlet 21. According to this embodiment, the mouth opening 26 is arranged upstream of the drive impeller 2. In particular, the mouth opening 26 leads into an inlet channel 17. According to this embodiment, the inlet channel 17 contains a compressor 45. In particular, the mouth opening 26 opens into the inlet channel 17 downstream of the compressor 15.

The return line 24 has an inlet opening 39, which is arranged downstream of the driven impeller 4. The inlet opening 39 can be annular if the entire housing 3 is formed as a double casing, with the flow chamber formed by the double casing forming the return line 24. In particular, the inlet opening 39 is arranged in a wall of the fluid space 52 for the driven impeller.

If a plurality of return lines 24 are provided, which is not shown in the drawing, a plurality of first partial volumes of the compressible medium 10, 11 flow in each of the return lines 24.

If the flow cross-section of the flow channel 30 in the first flow channel section 31 decreases, an increase in the flow velocity of the compressible medium in the first flow channel section occurs. Alternatively or additionally, a profiling or one or more guide elements can be arranged in the first flow channel section 31. A profiling or a guide element may be helical or spiral in shape and serve to deflect the flow of the compressible medium to generate a swirl, which will be described in connection with the sixth embodiment in FIG. 7 to FIG. 12.

According to this embodiment, the drive shaft 5 comprises a substantially conical end which forms a tip. When the drive shaft 5 is arranged vertically, the tip can rest on a bottom plate of the housing 3, in which inlet openings are provided for the compressible medium 10, 11 that flows from the inlet channel 17 into the drive impeller 2.

FIG. 5 shows a longitudinal section of a drive unit 1 according to a fourth embodiment. The same reference signs are used for the same or similarly acting elements as in the preceding embodiments. For the description of the features related to the flow of the compressible medium, reference can be made to the description of the embodiment according to FIG. 3 or FIG. 4. The embodiment according to FIG. 5 differs in particular from the preceding embodiments in that the drive shaft 5 and the output shaft 6 have no mechanical connection to each other. The drive shaft 5 and the output shaft 6 are not coupled via a coupling mechanism. Thus, the drive shaft 5 and the output shaft 6 are mechanically decoupled. The drive shaft 5, which carries the drive impeller 2 and is therefore invisible in the present embodiment, is rotatably mounted in the housing 3. The housing 3 contains the flow body 35, which may have a blind bore in which the drive shaft 5 is received. The opposite end of the drive shaft may be rotatably received in a holder for a starting device 12. The starting device 12 may be in the form of a drive device for the drive shaft, which is suitable for driving the drive shaft 5 and the drive impeller 2 which is non-rotatably connected to the drive shaft 5.

By means of the drive impeller 2, a flow of the compressible medium 10, 11 is generated at least in a start phase, which enters the flow channel 30 downstream of the drive impeller 2 in the inlet 21. As already shown in FIG. 3 or FIG. 4, the flow channel 30 comprises a first flow channel section 31 and a second flow channel section 32. In the first flow channel section 31, the compressible medium flows through a first channel portion 33 and a second channel portion 34, which are arranged next to each other. As shown in FIG. 3 or FIG. 4, the second channel portion 34 can be heated by means of a heating element 36. Also, the course of the flow cross-section in the first channel portion 34 and the second flow channel section may be selected as in the preceding embodiments to improve the suction of the heated compressible medium from the second channel portion 34 in the mouth region 37. By utilizing the Venturi effect as well as the thermal energy of the heated compressible medium 11 in the second channel portion 34, the flow rate of the heated compressible medium 11 in the second flow channel section 32 can be further increased. Furthermore, by means of a jacket element 38, which effects an insulation of the second flow channel section 32 or may contain an additional heating element, it can be ensured that the greatest possible flow velocity can be provided at the outlet 22 for entry into the driven impeller 4.

The driven impeller 4 is non-rotatably connected to the output shaft 6. The output shaft 6 is thus driven by the driven impeller 4 when the heated compressible medium flows through it. The output shaft 6 can in turn be rotatably mounted in a blind bore of the housing 3, in particular of the stationary flow body 35 belonging to the housing 3. Alternatively or in addition thereto, a bearing point may be provided in the outlet channel 47, which is not shown in the drawing. The output shaft 6 can be used to drive a generator, although the generator is also omitted in the present embodiment because any commercially available generator can be used.

FIG. 6 shows a longitudinal section of a drive unit 1 according to a fifth embodiment, which differs from the previous embodiment in that the second flow channel section 34 is omitted. In contrast to the embodiment according to FIG. 2, a heating element 36 is provided for the compressible medium 10 flowing through the first flow channel section 31. According to this embodiment, the compressible medium 10 flowing in the first flow channel section 31 of the flow channel 30 is thus heated to form a heated compressible medium 11. Advantageously, the second flow channel section 32 is again surrounded by a jacket element 38 for insulation or temperature control purposes. Also for this embodiment, the combination of the Venturi effect with a heating of the compressible medium is used to obtain the optimum flow velocity at the outlet 22 for entry into the driven impeller 4. In a variation of the embodiment, the jacket element 38 can be arranged around the entire housing 3, in particular surrounding the first flow channel section 31 as well as the heating element 36, so that in particular no heat can escape from the heating element 36 into the environment.

FIG. 7 shows a radial section of a drive unit 1 according to a sixth embodiment, which shows an embodiment of the drive impeller 2. As shown in FIG. 9, this embodiment includes a circulation device 23 as described in FIG. 4. Also shown in FIG. 7 is a plurality of outlet openings of a side channel 46 leading outwardly from the fluid space 51 for the drive impeller or from the flow channel 30 (see FIG. 4 or FIG. 9), which serves as an outlet channel for the compressible medium 10, 11 that is no longer needed.

The drive impeller 2 contains a plurality of guide vanes 53 arranged in an annular shape. According to the present embodiment, the guide vanes 53 have an angle of inclination of 30 to 60 degrees with respect to the longitudinal axis 9. A compressible medium 10 flowing in substantially in the axial direction, in particular parallel to the longitudinal axis 9, is imposed with a radial component for the flow, so that a spiral flow is generated.

FIG. 8 shows a radial section of a drive unit 1 according to the sixth embodiment, which shows the driven impeller 4. The driven impeller 4 includes a plurality of guide vanes 54 arranged in an annular shape. According to the present embodiment, the guide vanes 54 have an angle of inclination of 30 up to and including 60 degrees with respect to the longitudinal axis 9 (perpendicular to the drawing plane). The inflowing heated compressible medium 10 has a radial component for the flow, which becomes clearer in connection with FIG. 9 and FIG. 12, so that the flow onto the guide vanes 54 of the driven impeller 4 can be substantially perpendicular to the flow direction, whereby the surface of the guide vanes 54 against which the flow is directed can be optimally utilized.

FIG. 9 shows a longitudinal section of a drive unit 1 according to the sixth embodiment. The same reference signs are used for the same or similarly acting elements as in the preceding embodiments. For the description of the features related to the flow of the compressible medium, reference can be made in particular to the description of the embodiment according to FIG. 4. According to the present embodiment, the flow channel 30 has a profiling 41 which is helical or spiral in shape. In FIG. 9 as well as in FIG. 12, the profiling is provided for the first channel portion 33 as well as the second flow channel section 32. A plurality of fluid conduits 42 can be formed by the profiling 41. When a plurality of fluid conduits 42 are provided, a partial volume of the compressible medium 10, 11 flowing through the first channel portion 33 flows in each of the fluid lines 42. Thus, according to this embodiment, the first channel portion 33 comprises a plurality of fluid lines 42.

When the flow cross-section of the flow channel 30 decreases in the first flow channel section 31, there is an increase in the flow velocity of the compressible medium 10, 11 in each of the fluid lines. In addition, the compressible medium 10, 11 flows through the flow channel 30 toward the second flow channel section 32 while forming a twist. Due to the spiral shape of the fluid lines 42, a twist is forcibly imposed on the compressible medium in the fluid lines 42. Due to the profilings 41, the vector illustrating the flow velocity of the compressible medium 10, 11 contains an axial component and a radial component of the flow velocity, so that a twist is created. This twist is further enhanced by the heated compressible medium 10, 11 flowing radially through the mouth region 37 from the second channel portion 34. In addition, the cross-sectional area of each fluid line 42 decreases progressively up to the mouth region 37 where the second channel portion 34 opens into the fluid lines 42, which is shown in the sectional view according to FIG. 10c.

Alternatively, one or more guide elements can be arranged in the first flow channel section 31. Such a guide element can be helical or spiral in shape and serve to deflect the flow of the compressible medium to create a twist.

If a swirl flow is generated by profiling or guide elements in the flow channel 30, the inflow angle of the compressible medium 10, 11 impinging on the guide vanes of the driven impeller 4 can be optimized so that an almost loss-free flow to the guide vanes 54 of the driven impeller 4 can be obtained.

In particular, the heated compressible medium can flow towards the driven impeller 4 at an optimum inflow angle due to the twist in the second flow channel section 32 when the fluid lines 42 continue from the first flow channel section 31 into the second flow channel section 32. In particular, the fluid lines 42 in the second flow channel section 32 also have a spiral shape. The suction effect can be further enhanced if the flow channel 30 is heated or a heated compressible medium 11 is supplied to the flow channel 30, in particular as already described in connection with the embodiment according to FIG. 4. Additionally, a heating element may be provided in the flow body 35, which is not shown in the drawing.

FIG. 10a shows a radial section of a drive unit 1 according to the sixth embodiment, which shows the flow channel 30 in the first flow channel section 31. The sectional plane is marked A-A in FIG. 9. According to this embodiment, the flow channel 30 in the first flow channel section 32 comprises the first channel portion 33 and the second channel portion 34. The first channel portion 33 contains a plurality of fluid lines 42, in the present embodiment 8 fluid lines 42 are shown as an example. The second channel portion 34 is annular and surrounds the first channel portion 33. In addition, the return line 24 of the circulation device 23 is also shown. According to this embodiment, the return line 24 is annular.

FIG. 10b shows a radial section of a drive unit 1 according to the sixth embodiment, which shows the flow channel 30 with the heating element 36. The sectional plane is marked B-B in FIG. 9. According to this embodiment, the flow channel 30 in the first flow channel section 32 consists of the first channel portion 33 and the second channel portion 34. The channel portion 33 contains a plurality of fluid lines 42, in the present illustration 8 fluid lines 42 are shown as an example. Compared to the illustration according to FIG. 10a, the flow cross-section of the fluid lines 42 has already been reduced to less than half of the flow cross-section according to FIG. 10a. The second channel portion 34 is annular and surrounds the first channel portion 33. In addition, the return line 24 of the circulation device 23 is also shown. According to this embodiment the return line 24 is annular. The heating element 36 is arranged between the first channel portion 33 and the second channel portion 34. The heating element 36 is also arranged in an annular shape around the first channel portion 33.

FIG. 10c shows a radial section of a drive unit 1 according to the sixth embodiment, which shows the mouth region 37. The sectional plane is marked C-C in FIG. 9. The first and second channel portions 33, 34 open into a common flow channel 30 in the mouth region 37, which also runs spirally in the second flow channel section and whose cross-section is minimal at the location shown in FIG. 10c.

FIG. 11 shows a view of the arrangement of drive elements of the drive unit 1 according to the sixth embodiment. A starting device 12 is located in the inlet channel 17, which is not shown. The starting device 12 comprises a compressor, in particular a fan, and an associated drive motor. The drive impeller 2 is connected to the drive shaft 5 in a rotationally fixed manner. The driven impeller 4 is connected to the output shaft 6 in a rotationally fixed manner. According to this embodiment, the drive shaft 5 and the output shaft 6 are connected by a connecting rod 55, but are rotatable relative to each other. The connecting rod 55 is primarily provided to fix the distance between the drive impeller 2 and the driven impeller 4. The rotational movement of the drive impeller 2 occurs independently of the rotational movement of the driven impeller 4. In particular, the driven impeller 4 can have a higher rotational speed than the drive impeller 2 in the operating state.

FIG. 12 shows a view of the flow channel 30 of the drive unit 1 according to the sixth embodiment. FIG. 12 shows the course of the flow channel 30 from the inlet 21 to the outlet 22, i.e. the first flow channel section 31 and the second flow channel section 32. In the first flow channel section 31, however, only the first channel portion 33 is shown, the second channel portion 34 is omitted in this illustration; it could also be omitted according to the embodiment shown in FIG. 2 or FIG. 6. The flow channel 30 includes a plurality of fluid lines 42. As in the previous embodiments, the fluid lines 42 are formed as closed channels of the flow body 35, which are arranged in a spiral shape.

The flow body 35 does not necessarily have to be of monolithic construction, as shown in FIG. 9, the first flow channel section 31 is part of a first partial body of the flow body 35 and the second flow channel section 32 is part of a second partial body of the flow body 35. The flow body 35 is fixed in the area of the inlet 21 on a plate element 57, which delimits the fluid space 51 of the drive impeller. The plate element 57 has corresponding openings for the passage of the compressible medium 10, 11. The fluid space 51 of the drive impeller 2 is delimited by a drive impeller housing 56. The drive impeller housing 56 contains a base element which also has openings for the passage of the compressible medium 10, 11. A jacket element 58 extends between the base element and the plate element 47, in which the mouth openings 26 of the circulation device 23 and/or the side channel or channels 46 for the compressible medium that is no longer required are arranged, see FIG. 8 and FIG. 9.

FIG. 13 shows an embodiment of a heat accumulator 7 and a heat exchanger 8 for a system 100 according to one of the preceding embodiments. The heat exchanger 8 for heating a compressible medium 10 is fed by the heated heat transfer fluid 19 circulating in the tubes of the heat exchanger 8 configured as a shell-and-tube heat exchanger, so that a heated compressible medium 11 can be generated. According to the present embodiment, the heated heat transfer fluid 19 flows within the tubes. The heat transfer fluid 19 is provided in the heat accumulator 7. The heat accumulator 7 can be supplied by a heat source 13 not shown, selected from the group consisting of a solar cell, a photovoltaic panel, an internal combustion engine, a fuel cell, a fossil fuel burner element.

FIG. 14 shows an embodiment of a heat accumulator 7 for a system 100 according to one of the preceding embodiments. According to FIG. 14, this heat accumulator 7 is configured as a fuel cell 27. The fuel cell 27 contains a plurality of reaction units 28 as well as a storage tank 29 each for oxygen and hydrogen.

Each of the features described can be used in any of the variants or embodiments. The variants or embodiments according to FIG. 2 to FIG. 12 can therefore be combined in any way.

According to any of the preceding embodiments, the system 100 can comprise a monitoring unit. By means of the monitoring unit, operating parameters that are detected by means of sensors can be determined and monitored. The monitoring unit can comprise a control unit, by means of which temperatures and pressures of the compressible medium, speeds of the drive shaft or the output shaft, operating times of the system can be controlled with respect to preset or predetermined set values.

According to any of the embodiments, a plurality of drive impellers or driven impellers may be provided, which may be arranged in series on the drive shaft or the output shaft to further reduce incident flow losses.

It is obvious to the person skilled in the art that many further modifications in addition to the described embodiments are possible without deviating from the inventive concept. Thus, the subject matter of the invention is not limited by the preceding description and is determined by the scope of protection defined by the claims. For the interpretation of the claims or the description, the broadest possible reading of the claims is decisive. In particular, the terms “comprising” or “including” are intended to be interpreted as referring to elements, components, or steps in a non-exclusive meaning, thereby indicating that the elements, components, or steps may be present or may be used, may be combined with other elements, components, or steps not explicitly recited. When the claims refer to an element or component from a group that may consist of A, B, C through N elements or components, this phrase is intended to be interpreted as requiring only a single element of that group, and not a combination of A and N, B and N, or any other combination of two or more elements or components of that group.

1. A drive unit for a generator, the drive unit comprising a housing, a flow channel for a compressible medium, a drive impeller and a driven impeller, wherein the flow channel is arranged in the housing, with the flow channel extending from the drive impeller to the driven impeller, wherein the drive impeller is rotatably mounted on a drive shaft and the driven impeller is rotatably mounted on an output shaft, wherein at least one of the drive shafts or output shafts is rotatably mounted in the housing, wherein the housing contains a flow body, wherein the flow body is arranged between the drive impeller and the driven impeller, wherein the flow body is configured in such a way that a flow cross section of the flow channel extending through the flow body in a flow direction of the compressible medium is continuously reduced.

2. The drive unit of claim 1, wherein the flow body is configured such that the flow cross section of the flow channel in the flow direction of the compressible medium continuously decreases through the flow body.

3. The drive unit of claim 1, wherein the flow body is configured such that the flow cross section of the flow channel in the flow direction of the compressible medium widens continuously.

4. The drive unit of claim 1, wherein the flow channel downstream of the drive impeller divides into a first channel portion and a second channel portion.

5. The drive unit of claim 4, wherein a heating element is arranged between the first and the second channel portions.

6. The drive unit of claim 5, wherein the second channel portion opens into the first channel portion in a mouth region, where the flow channel has a smallest flow cross-section.

7. The drive unit of claim 1, wherein the driven impeller can be coupled with the output shaft to operate a generator.

8. The drive unit of claim 1, wherein the drive impeller can be set into a rotational movement by means of a starting device at least in a run-in phase.

9. The drive unit of claim 1, wherein a compressor is arranged upstream of the drive impeller.

10. The drive unit of claim 1, wherein a circulation device for the compressible medium is provided for recirculation into the flow channel.

11. The drive unit of claim 10, wherein the circulation device includes a return line.

12. The drive unit of claim 11, wherein the return line extends from the output impeller to the drive impeller.

13. The drive unit of claim 1, wherein the flow body has a profiling or the flow channel contains at least one guide element.

14. The drive unit of claim 13, wherein the profiling comprises a plurality of spiral fluid channels.

15. A system for electric power generation comprising a drive unit wherein the drive unit comprises a housing, a flow channel for a compressible medium, a drive impeller and a driven impeller, wherein the flow channel is arranged in the housing, with the flow channel extending from the drive impeller to the driven impeller, wherein the drive impeller is rotatably mounted on a drive shaft and the driven impeller is rotatably mounted on an output shaft, wherein at least one of the drive shafts or output shafts is rotatably mounted in the housing, wherein the housing contains a flow body, wherein the flow body is arranged between the drive impeller and the driven impeller, wherein the flow body is configured in such a way that a flow cross section of the flow channel extending through the flow body in a flow direction of the compressible medium is continuously reduced.
